(19) United States
(12) Patent Application Publication
(10) Pub. No.: US 2015/0109095 A1
(43) Pub. Date: Apr. 23, 2015

(54) METHOD AND COMPUTER PROGRAM PRODUCT FOR INTERCONNECTING FUNCTIONAL GRAPHICAL ELEMENTS

(71) Applicant: DISTECH CONTROLS INC., Brossard (CA)

(72) Inventors: Patrice Soucy, Brossard (CA); Xiao Chiao Sun, Brossard (CA)

(73) Assignee: DISTECH CONTROLS INC., Brossard (CA)

(21) Appl. No.: 14/192,899

(22) Filed: Feb. 28, 2014

Related U.S. Application Data
(60) Provisional application No. 61/892,736, filed on Oct. 18, 2013.

(51) Int. Cl. G05B 19/04; G05B 19/042

(52) U.S. Cl. CPC G05B 19/041; G05B 19/0426
USPC 340/4.3

(57) ABSTRACT

The present disclosure relates to a computer-implemented method for interconnecting functional graphical elements. The method identifies a first functional graphical element on a display of a computer. The method further identifies at least one second functional graphical element on the display. The method then determines by a processor of the computer that the at least one second functional graphical element has a pre-determined position on the display with respect to the first functional graphical element. The method then functionally connects the at least one second functional graphical element to the first functional graphical element.

### TECHNICAL FIELD

The present disclosure relates to the field of configuration and programming of computing devices exchanging data. More specifically, the present disclosure relates to a computer-implemented method and computer program product for interconnecting functional graphical elements in a configuration environment.

### BACKGROUND

Systems for controlling environmental conditions, for example in buildings, are becoming increasingly sophisticated. A control system may at once control heating and cooling, monitor air quality, detect hazardous conditions such as fire, carbon monoxide release, intrusion, and the like. Such control systems generally include at least one environment controller, which receives measured environmental values, generally from external sensors, and in turn determines set-points or command parameters to be sent to controlled appliances.

The environment controller is a computing device with a processor, which executes instructions of a dedicated configuration program to process the measured environmental values received from the sensors and generate the set-points or command parameters sent to the controlled appliances. The dedicated configuration program may have been directly programmed in a computing language such as C, C++ or assembly code. Alternatively, a graphical configuration tool may be used to generate the dedicated configuration program. The graphical configuration tool is executed by a processor of a computer and a graphical interface of the tool is provided on a display of the computer. A user of the tool selects functional graphical elements (e.g. environment controller, sensor, controlled appliance, operations to be performed, etc.) representing devices and operations with the graphical interface, and the selected functional graphical elements are displayed on the display. The user also generates (via the graphical interface) links between the functional graphical elements to represent the flow of data between the functional graphical elements. For example, the functional graphical elements of several sensors are connected to the functional graphical element of an environment controller, to specify that data are transmitted from the sensors to the environment controller, where they are processed.

However, in the case of a complex environment control system, several functional graphical elements may be displayed and interconnection between the functional graphical elements must be performed manually by a user of the graphical interface. Therefore, the process of manually connecting (via the graphical interface) the functional graphical elements of several sensors to the functional graphical element of an environment controller may be tedious and time consuming. There is hence a need to automate the process of interconnecting functional graphical elements.

### SUMMARY

In accordance with a first aspect, the present disclosure relates to a computer-implemented method for interconnecting functional graphical elements of devices. The method comprises displaying a first functional graphical element on a display of a computer, and displaying at least one second functional graphical element on the display. The method further comprises determining by a processor of the computer that the at least one second functional graphical element has a pre-determined position on the display with respect to the first functional graphical element. The method also comprises functionally connecting the at least one second functional graphical element to the first functional graphical element.

### BRIEF DESCRIPTION OF THE DRAWINGS

Embodiments of the disclosure will be described by way of example only with reference to the accompanying drawings, in which:

FIG. 1 illustrates an example of an environment control system;

FIG. 2 illustrates an exemplary environment control device (ECD) used in the environment control system of FIG. 1;

FIG. 3A-3C illustrates a computer-implemented method for interconnecting functional graphical elements; and

FIGS. 4-7 illustrate a graphical interface of a graphical configuration tool providing interconnection of functional graphical elements; and

FIG. 8 illustrates a computer for executing instructions comprised in a computer program product for interconnecting functional graphical elements.

### DETAILED DESCRIPTION

The foregoing and other features will become more apparent upon reading of the following non-restrictive description of illustrative embodiments thereof, given by way of example only with reference to the accompanying drawings. Like numerals represent like features on the various drawings.

Various aspects of the present disclosure generally address one or more of the problems related to the interconnection of functional graphical elements in a graphical configuration tool, and more specifically in the context of functional graphical elements for use in an environment control system configuration.

### Terminology

The following terminology is used throughout the present disclosure:
Environment: condition(s) (temperature, pressure, oxygen level, light level, security, etc.) prevailing in an area or place, such as for example in a building.
Environment control system: a set of components and devices which interact for monitoring and controlling an environment.
Environmental data: any data (e.g. information, commands) related to an environment that may be exchanged between components of an environment control system.
Environment control device (ECD): generic name for a component of an environment control system. An ECD may consist of an environment controller, a sensor, a controlled appliance, etc.
Environment controller: device capable of receiving information related to an environment and sending commands based on such information.
Environmental characteristic: measurable, quantifiable or verifiable property of an environment.
Environmental characteristic value: numerical, qualitative or verifiable representation of an environmental characteristic.
Sensor: device that detects an environmental characteristic and provides a numerical, quantitative or verifiable representation thereof. The numerical, quantitative or verifiable representation may be sent to an environment controller.
Controlled appliance: device that receives a command and executes the command. The command may be received from an environment controller.
Processing module: processor, computer, or like device or component capable of executing mathematical or logical operations and execute code.
Environmental state: a current condition of an environment based on an environmental characteristic, each environmental state may comprise a range of values or verifiable representation for the corresponding environmental characteristic.
Communication module: device or component capable of providing communication functionalities based on a specific communication technology (for example a standardized or proprietary wired communication technology, or a standardized or proprietary wireless communication technology). A specific protocol or set of protocols corresponding to the specific communication technology is implemented by the communication module.
Functional graphical element: Element provided in a graphical configuration tool, for representing an environmental control device or any operation performed on any of the following, taken solely or in combinations: the environmental characteristic, the environmental characteristic value, the environmental data and/or the environmental state.
Wi-Fi: any Wireless Local Area Network (WLAN) product that is based on the Institute of Electrical and Electronics Engineers' (IEEE) 802.11 standards.
Wi-Fi hotspot: communication infrastructure allowing communications between devices using communication protocols based on the 802.11 standards. The hotspot is established by a dedicated device. A device needs to associate with the Wi-Fi hotspot, before being capable of using it for communications with other devices.

### Environment Control System and Environment Control Devices

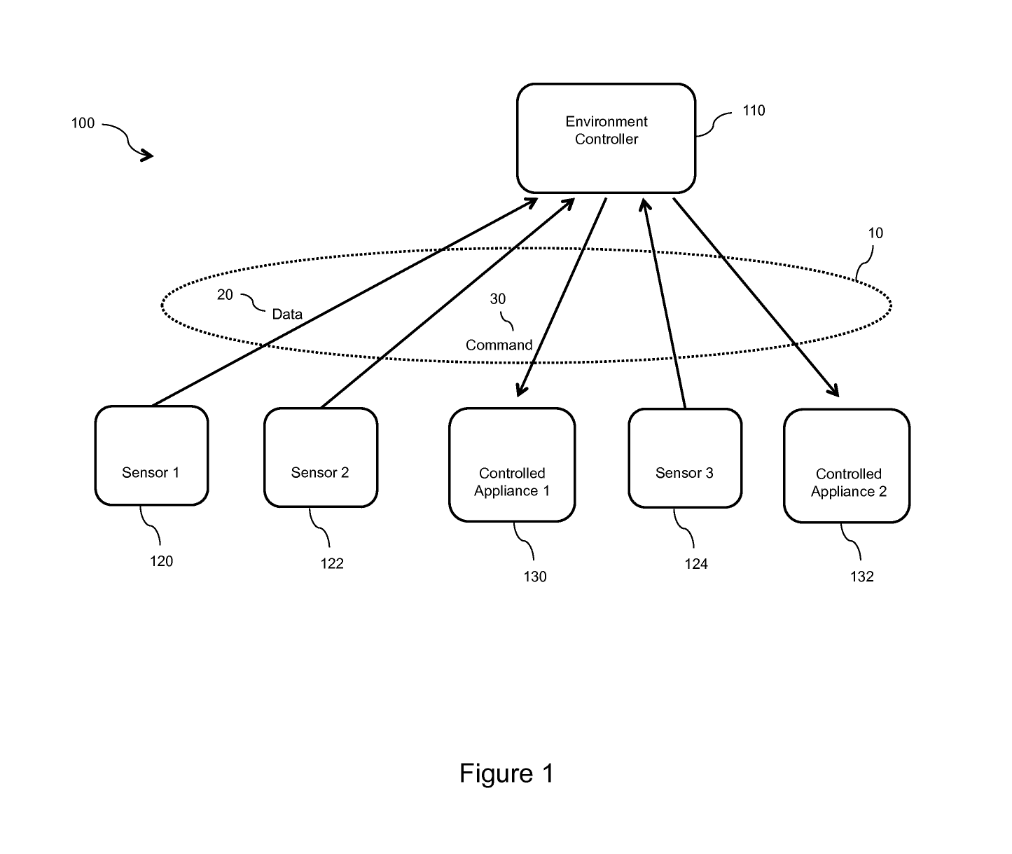

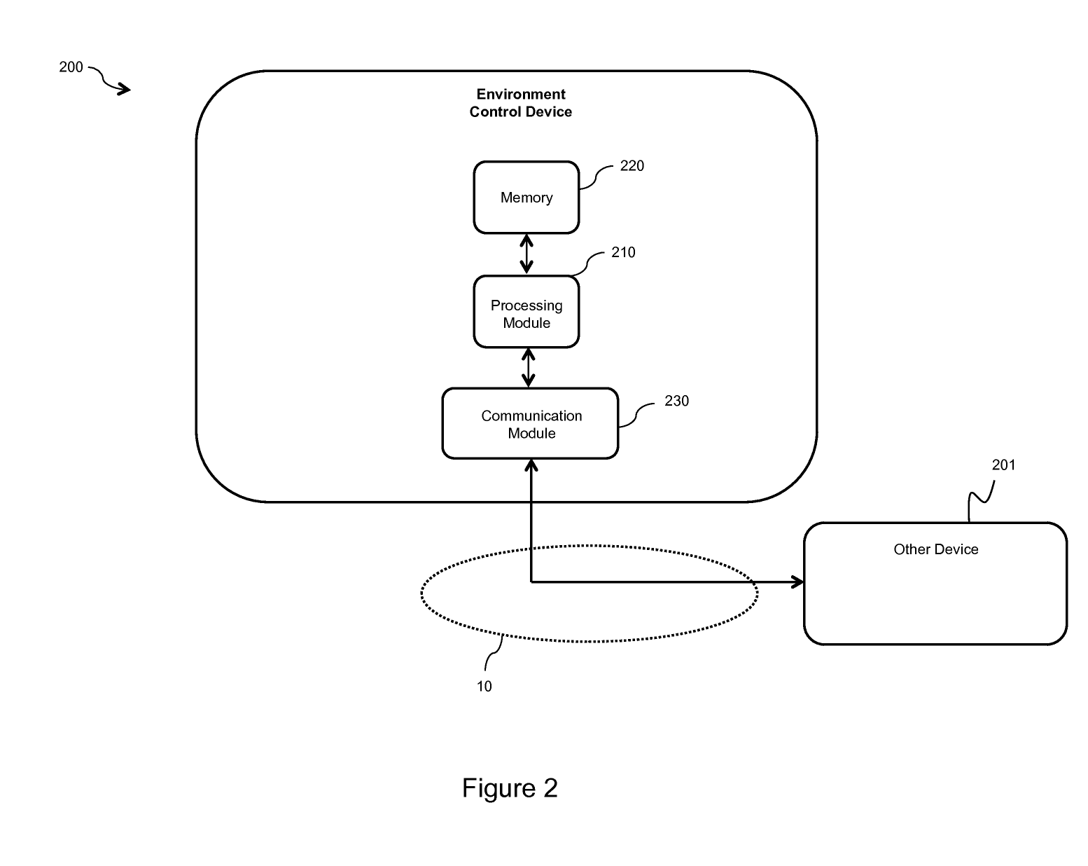

Referring now concurrently to FIGS. 1 and 2, an exemplary environment control system 100 comprising several environment control devices (ECDs) 200 is represented. The environment control system 100 is deployed in a controlled area such as a building (not represented in FIG. 1). The environment control system 100 comprises different types of ECDs 200: an environment controller (110), sensors (120, 122 and 124), and controlled appliances (130 and 132).

All these ECDs 200 exchange information over a communication network 10. The communication network 10 may comprise a wireless communication infrastructure (e.g. one or several Wi-Fi hotspots). Alternatively, the communication network 10 may comprise a wired communication infrastructure (e.g. an Ethernet network). The communication network 10 may also comprise a combination of a wireless communication infrastructure and a wired communication infrastructure.

The sensors (120, 122 and 124) transmit data 20 to the environment controller 110 over the communication network 10. The data 20 generally consist of environmental characteristic values.

The environment controller 110 transmits commands 30 to the controlled appliances (130 and 132) over the communication network 10.

The ECD 200 comprises a communication module 230 for exchanging information with one or several other devices 201 via the communication network 10. The other device 201 generally consists of another ECD. The information exchanged consists of environmental characteristic values (transmitted from a sensor to an environment controller) or commands (transmitted from an environment controller to a controlled appliance).

The ECD 200 also comprises a processing module 210, for processing information received via the communication module 230 from another device 201 and/or for generating information transmitted via the communication module 230 to another device 201. In the case of the environment controller 110, the processing module 210 receives environmental characteristic values transmitted by the sensors (120, 122 and 124), processes these values, and generates commands transmitted to the controlled appliances (130 and 132).

The ECD 200 also comprises a memory 220. The memory 220 is capable of storing environmental characteristic values received via the communication module 230. The memory 220 is also capable of storing data (e.g. environmental states) which result from the processing by the processing module 210 of environmental characteristic values received via the communication module 230.

The processing module 210 of the environment controller 110 executes instructions of a dedicated configuration program to process the environmental characteristic values received via the communication module 230, to generate data such as environmental states stored in the memory 220, and to generate commands transmitted via the communication module 230. For instance, the dedicated configuration program may transform temperature values received from a temperature sensor and expressed in Fahrentheit, into temperature values expressed in Celsius. Additionally, the dedicated configuration program may compare temperature and humidity values received from temperature and humidity sensors with respective thresholds, and generate a command to be sent to a controlled air conditioner based on the result of the comparison.

### Computer-Implemented Method for Interconnecting Functional Graphical Elements of Devices

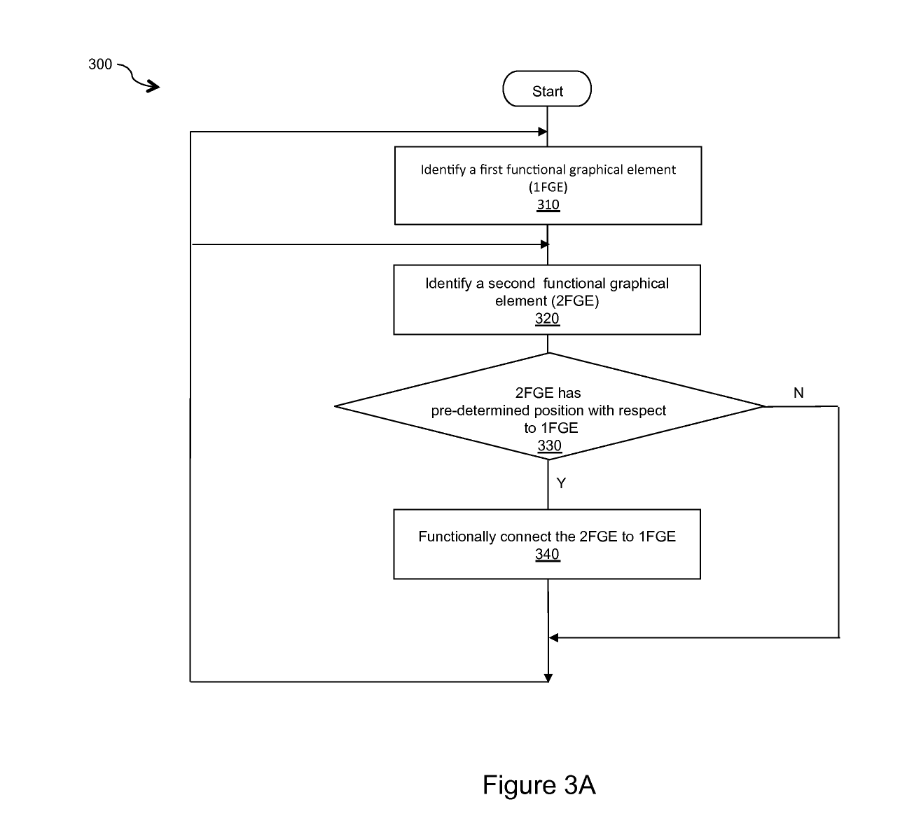

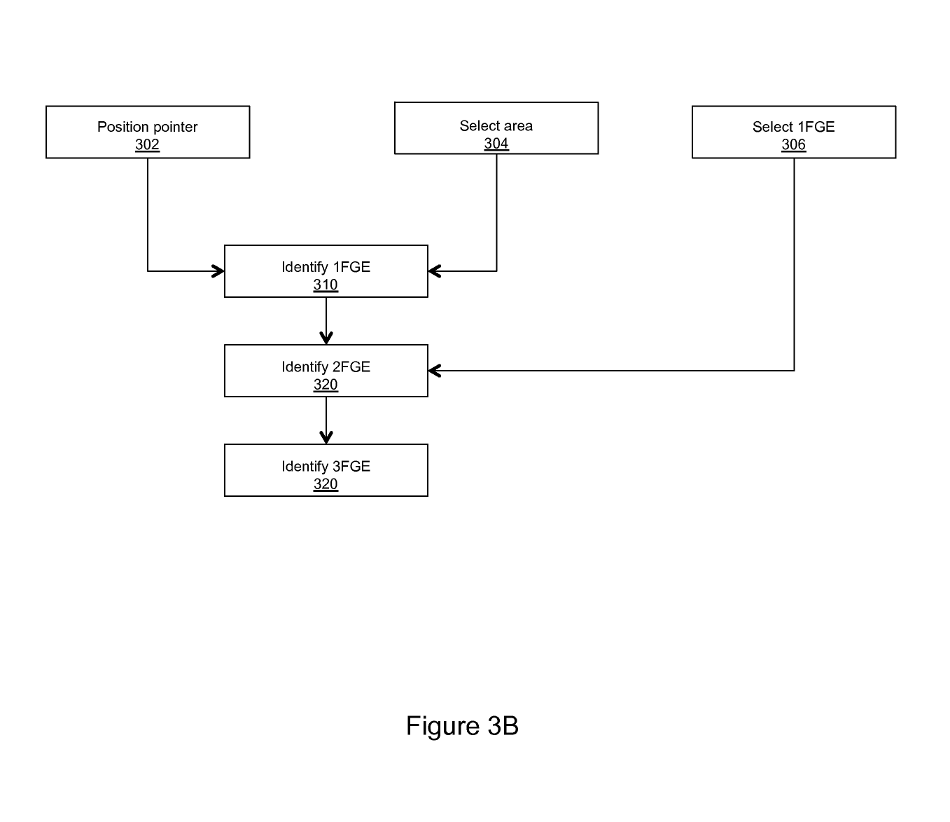

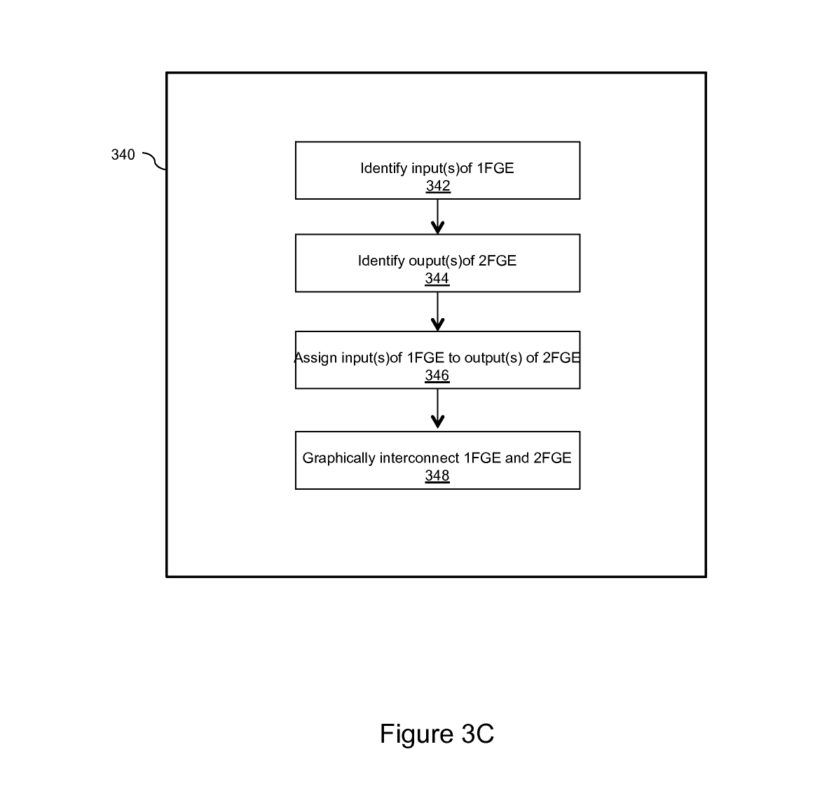

Referring now concurrently to FIGS. 3-7, a computer implemented method 300 for interconnecting functional graphical elements (FGE) of devices or operations and a graphical interface 400 of a graphical configuration tool are represented.

The graphical configuration tool is used to automatically generate a dedicated configuration program to be executed by the devices of the environment control system. Depending on the implementation selected, all the devices may be configured with the same dedicated configuration program, only the same types of devices are configured with the same dedicated configuration program, and/or all devices are configured with their own dedicated configuration program. The graphical configuration tool is executed by a processor of a computer and the graphical interface 400 of the tool is displayed on a display of the computer. A user of the graphical configuration tool interacts with the graphical interface 400 to generate the dedicated configuration program.

The method 300 comprises identifying 310 a first functional graphical element (1FGE) of the display of the computer. The identification of the first functional graphical element may be performed in many different ways. The 1FGE may be identified by positioning 302 a pointer by means of a mouse by a user, on the graphical display. The 1FGE may also be identified by selecting 304 by a user, by means of a mouse, an area of the graphical display. In these two instances, the identification of the 1FGE is performed by identifying the 1FGE in the vicinity of the pointer, or within the selected area. In the event that several FGEs are located in the vicinity of the pointer, or within the selected area, one of the FGE is identified as 1FGE, and the other FGEs are then identified 320 (2FGE, 3FGE . . . ) by the graphical configuration tool based on their relative position on the graphical display: left vs. right, top vs. bottom, within a radius of, having at least a portion thereof located in the vicinity of the pointer or within the area selected by the user, etc.

Alternately, the user may directly select 306 one of the functional graphical element as the 1FGE by identifying by means for example of the mouse or of any other known input means, that the functional graphical element selected is the 1FGE.

The method continues by identifying the input and the output of the identified FGEs (steps 342 and 344), so as to determine how to interconnect them. More precisely, the method relies on the relative location of the FGEs on the display, to determine how to interconnect the input and output of the FGEs (step 346). The FGEs are generally graphically represented as elements having their input(s) on the left hand side, and their output(s) on the right hand side. Thus, the method uses a left to right, top to bottom identification scheme. For example, an input of an identified FGE is to be interconnected to an output of another FGE located on its left on the display, while an output of an identified FGE is to be interconnected to an input of a closest FGE located to its right, on the display. Additionally, the identification of the input(s) and output(s) may further be limited to FGEs located within a predetermined zone on the display. The predetermined zone may be customized by a user of the graphical tool, or preset by the manufacturer of the graphical tool. The predetermined zone corresponds to a maximum distance between the two FGEs to proceed to interconnection. Thus, when an FGE at the right is outside the predetermined zone, the interconnection will not be performed. The predetermined zone thus limits a zone of possible automatic interconnections.

Concurrently and/or alternatively, there may be no maximum distance between two FGEs for proceeding to interconnection and the predetermined zone then includes the whole page on which the FGEs are being displayed. Thus, an output of an identified FGE may be interconnected to an input of any FGE located to its right.

When the FGEs to be interconnected have been identified, and the input and output identified, assignment of the interconnections to be performed is started. The assignment includes applying the identification scheme, to determine which output is to be connected to which input. The identification scheme is performed in a left to right methodology. Then, a top to bottom methodology is also introduced. When the assignment 346 is completed, the method then graphically interconnects 348 the identified FGEs.

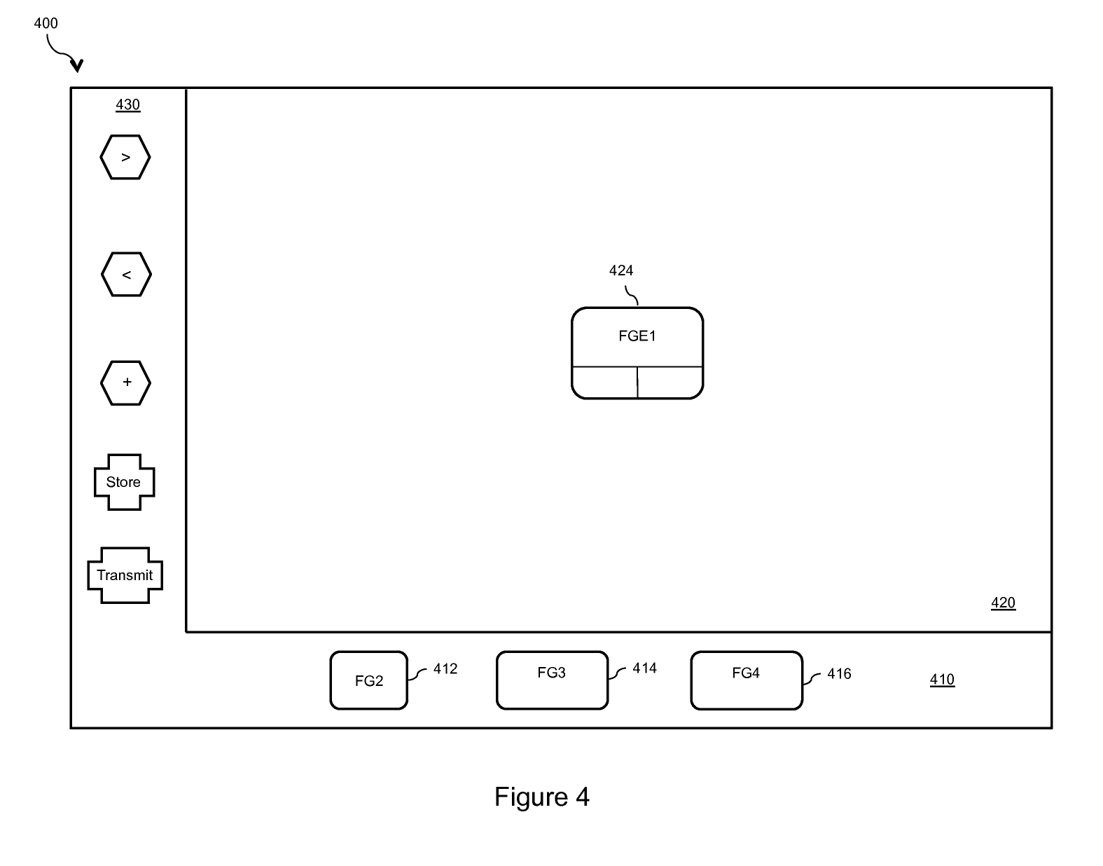

Reference is now made to FIG. 4. The graphical interface 400 comprises a region 410 where several types of FGEs can be selected. For instance, the first type of FGE 414 may consist in environment controllers. The second type of FGE 412 may consist in sensors. Additionally, a third type of FGE 416 may consist in controlled appliances 416. There could be many types of FGEs corresponding to various devices, and many other types of FGEs (not specifically shown for conciseness purposes) for operations to be performed between the devices.

The graphical interface 400 also comprises a configuration region 420 where the FGEs are displayed. To configure operational parameters of a device, group of devices, rooms and/or environment, a designer thus positions the corresponding FGEs on the display. The position of the FGEs with respect to one another will allow the automatic interconnection there between. Thus, FGEs which will be positioned too far apart, i.e. further than the predetermined zone, will not be automatically interconnected. FGEs positioned to the left, and within the predetermined zone, will see their outputs automatically connected to the inputs of the FGEs located to their right, etc.

For illustration purposes, three FGEs 422, 422′ and 422″ are positioned on the left of the configuration region. One FGE 424 is positioned to the center of the configuration region, while two FGEs 426 and 426′ are positioned to the right of the configuration region 420.

A user of the configuration graphical tool may thus position a pointer in the configuration region 420, select an area of the configuration region 420, or directly identify one of the FGEs to be interconnected. In the event that a pointer is positioned, or one FGE is selected 310 for interconnection, the present method and tool automatically assign the predetermined zone from the position of the pointer or the selected FGE to identify 320 all the other FGEs to be interconnected.

To continue the present description, assumption will be made that the FGE 424 has been identified 310 by a user as the 1FGE for interconnection purposes. The method 300 further comprises determining 330 by the processor of the computer that the FGEs within the predetermined zone have a pre-determined position with respect to 1FGE. In the present example, the FGEs (422, 422′ and 422″) are located within the predetermined zone in the configuration area of the display with respect to 1FGE (424). For instance, coordinates of the various FGEs displayed in the configuration region 420 of the display may be stored in a memory of the computer. The processor analyses the coordinates of the FGEs, to determine which FGEs are located within the predetermined zone. In the case when an area of the configuration area is selected by a user for interconnection purposes, all FGEs within that area will be considered, and interconnections performed between FGEs that are within the predetermined zone of each FGE.

To actuate the interconnection functionality of the graphical configuration tool, a user may either use a combination of keyboard keys, use a drop down menu displayed by a right-click or a left-click of the mouse, by hovering over one FGE for a predetermined time, or by any other means known on computers for actuating a function.

Each FGE in the configuration area 420 is displayed as having a title area, which may correspond to a name of a device or function which it represents. Each FGE also includes a lower portion, which is divided in two segments. The lower left segment corresponds to an input of the FGE, while the lower right segment corresponds to an output of the FGE. Depending on the function and/or device represented by the FGE, more than one input and/or output could be displayed. The number of inputs and/or outputs can be predefined by the graphical configuration tool, or customized by a user of the graphical configuration tool.

The method 300 thus determines the relative position of the identified FGEs, and determines their corresponding input and/or outputs.

The method 300 then comprises functionally connecting 340 the FGEs (422, 422′ and 422″) to the 1FGE (424), which are located within the predetermined zone of the input of the 1FGE. The connecting 340 may comprise displaying in the configuration area 420, link (423, 423′ and 423″) between the FGEs (422, 422′ and 422″) and the 1FGE (424). The connecting step 340 may further comprise memorizing in the memory of the computer the connection between the FGEs (422, 422′ and 422″) and the 1FGE (424).

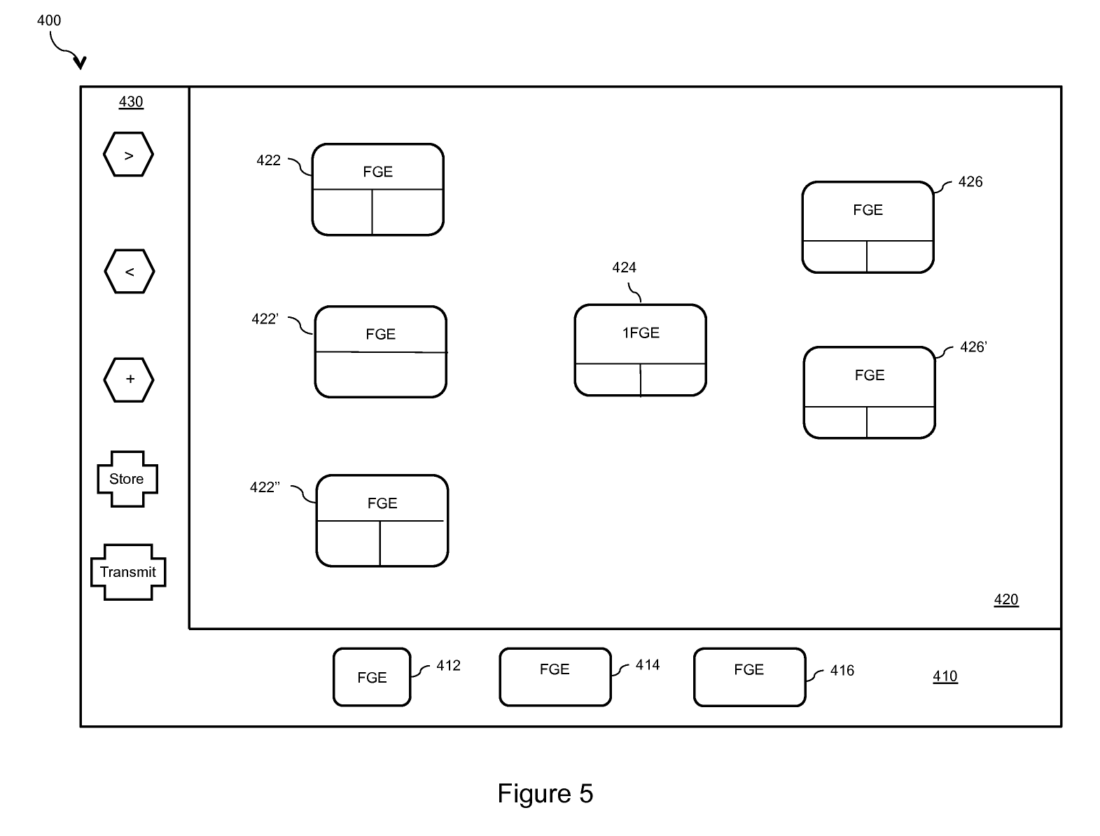

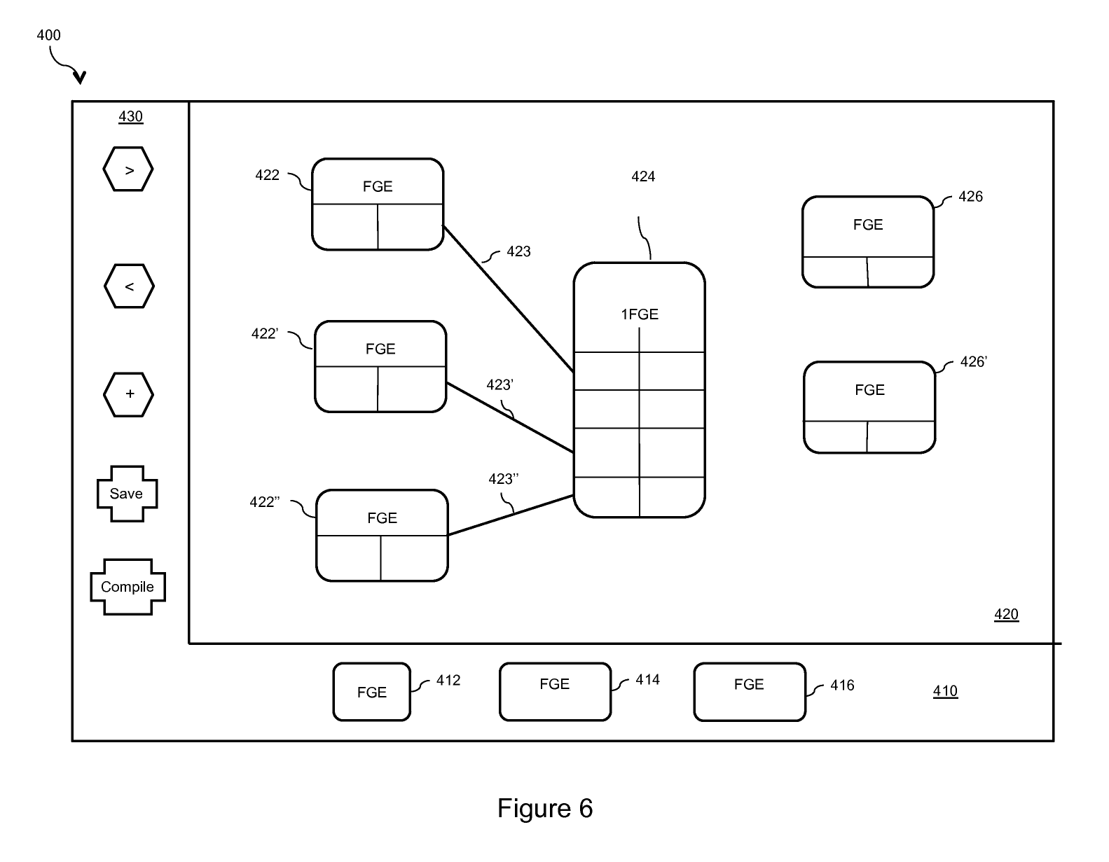

In FIGS. 5 and 6, the FGEs (422, 422′ and 422″) are located on the left of the 1FGE (424) in the configuration area 420, and it is the left to right relative positioning which determines the interconnections to be performed. However, the present method and tool are not limited to such a configuration. Depending on the preferences of the user of the graphical configuration tool, the determination of the relative position could be customized to any of the following: right to left, top to bottom, bottom to top, and left to right. Furthermore, any relative positioning taken alone of in combination, which can be analyzed and determined by the processor, may be used as a configuration methodology for interconnecting the FGEs (422, 422′ and 422″) with the 1FGE (424).

In FIGS. 3-7, the 2FGEs (422, 422′ and 422″) transmit data to the 1FGE (424). More specifically, the transmitted data may consist of environmental characteristic values transmitted from sensors (represented as FGEs 422, 422′ and 422″) to an environment the controller (represented as 1FGE 424). The links (423, 423′ and 423″) represent the flow of data between the FGEs. The graphical interface 400 also comprises a region 430 where a selection of operations can be performed.

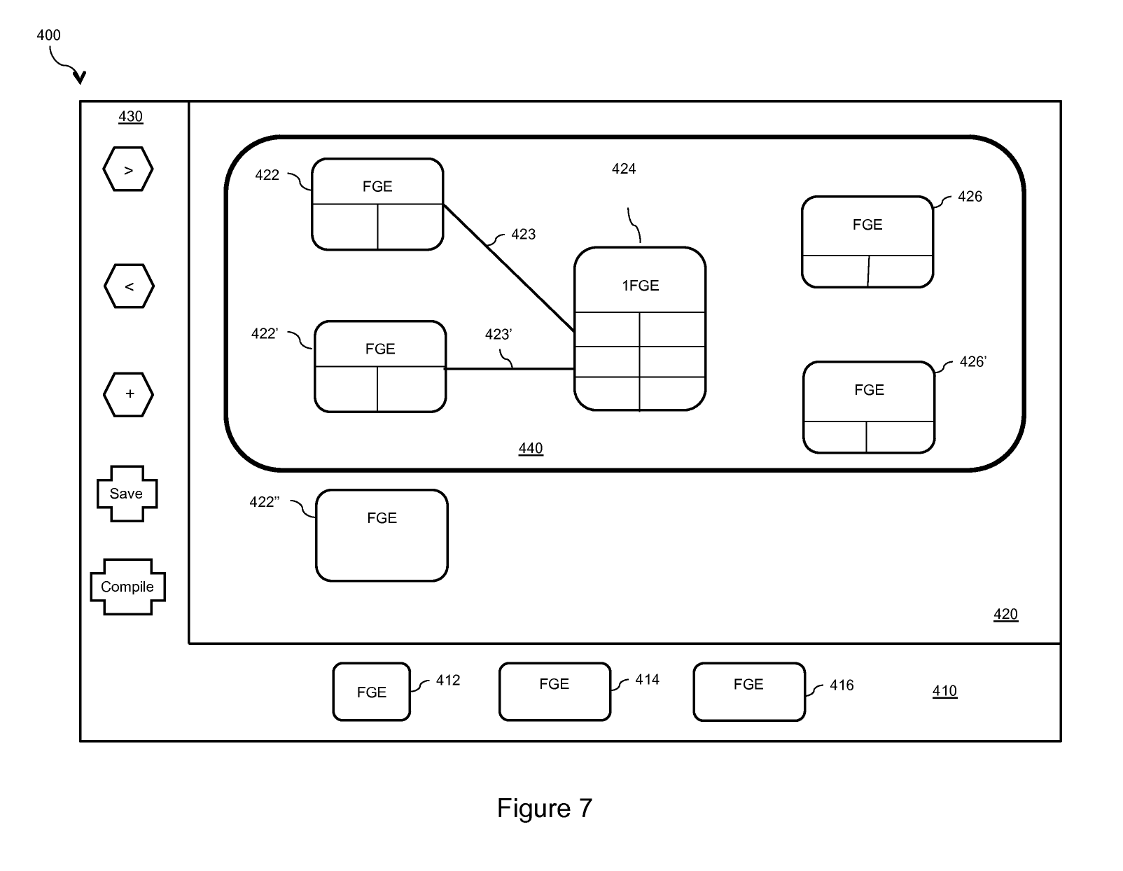

Referring now to FIG. 7, the automatic interconnections (423 and 423′) are performed only for FGEs (422, 422′ and 424) located in a selected section 440 of the configuration region 420.

The specific section 440 may be determined by an interaction of the user with the computer (e.g. defining a substantially rectangular region, as illustrated in FIG. 7, via the graphical interface 400). The specific section 440 may also be automatically computed by the processor, based on a particular algorithm out of the scope of the present disclosure. Alternatively, the specific section 440 may be determined by a combination of an interaction of the user with the computer and an automatic computation by the processor.

The user may directly select 306 one of the functional graphical element as the 1FGE and move the selected 1FGE within the configuration area 420 (by means for example of the mouse). The other steps of the method 300 (320, 330 and 340) may be performed for a proposed position of the 1FGE. For instance, when the user grabs the 1FGE by means of the mouse, moves the 1FGE in the configuration area 420, and stops moving the 1FGE for a determined period of time, the other steps of the method 300 are performed for the proposed position of the 1FGE before it is positioned by releasing the 1FGE. In particular, the interconnections between the 1FGE and the selected other FGEs are displayed for the proposed position, before the 1FGE is officially positioned. Thus, the user may test several proposed positions by grabbing and moving the 1FGE in the configuration area 420, and having the corresponding interconnections displayed. When the user is satisfied with a particular proposed position, he may indicate so (by means for example of the mouse by dropping the 1FGE as known in the art). Then, the 1FGE is permanently displayed at the particular current position and the corresponding interconnections are permanently displayed (or alternatively memorized in the memory of the computer).

### Computer Program Product for Interconnecting Functional Graphical Elements of Devices

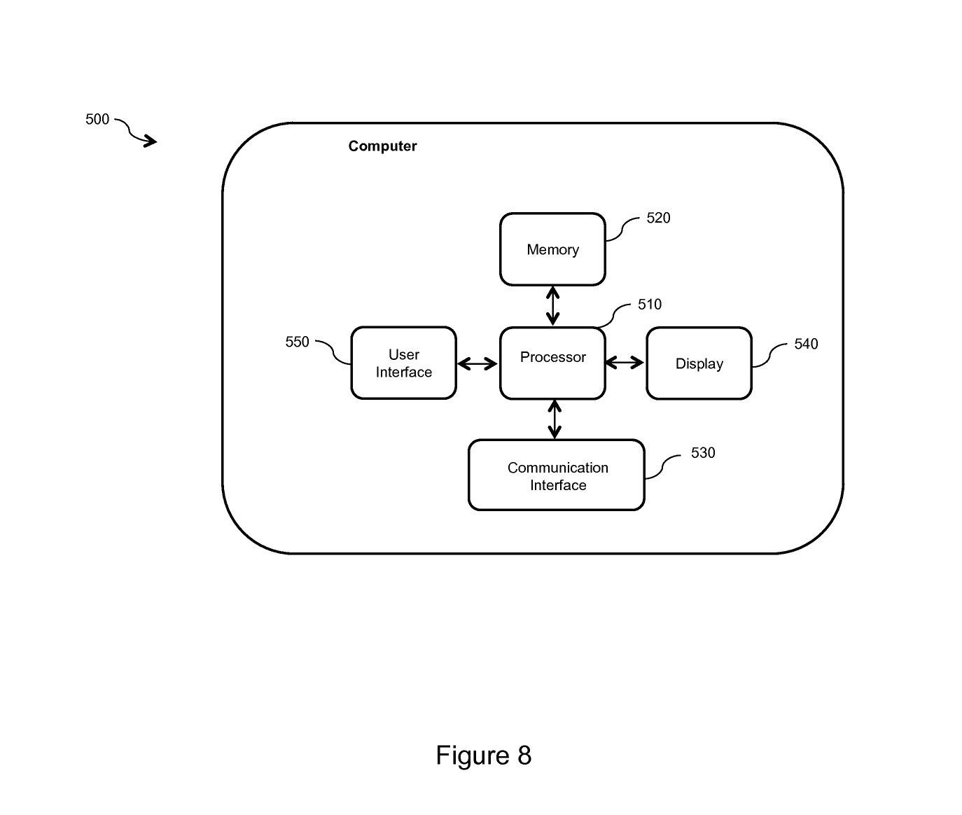

Referring now concurrently to FIGS. 6 and 8, a computer 500 for executing instructions comprised in a computer program product for interconnecting functional graphical elements of devices is represented.

The computer 500 includes a processor 510, a memory 520, a communication interface 530, a display 540, and a user interface 550.

The processor 510 executes instructions comprised in the computer program product for interconnecting FGEs, according to the aforementioned method. The computer program product is stored in the memory 520. The computer program product may be delivered to the memory 520 of the computer 500 via an electronically readable media (e.g. a storage media not represented in FIG. 8), or via communication links (e.g. Internet) using the communication interface 530.

The graphical interface 400 is displayed on the display 540 of the computer 500 and a user interacts with the graphical interface 400 via the user interface 550 of the computer 500.

When executed by the processor 510, the instructions of the computer program product identify a 1FGE 424 in the configuration area of the display 540. The instructions further perform an identification of at least one 2FGEs (422, 422′ and 422″) in the configuration area 420 on the display 540. The instructions perform a determination that the at least one 2FGEs (422, 422′ and 422″) has a pre-determined position in the configuration area 420 on the display 540 with respect to the 1FGE 424, and perform a subsequent functional connection of the at least one 2FGE to the 1FGE. Performing the subsequent functional connection of the at least one 2FGE (422, 422′ and 422″) to the 1FGE 424 may comprise memorizing in the memory 520 the connection between the at least one 2FGE (422, 422′ and 422″) and the 1FGE 424. Performing the subsequent functional connection of the at least one 2fGE (422, 422′ and 422″) to the 1FGE 424 may comprise displaying on the display 540 link (423, 423′ and 423″) between the at least one 2FGEs (422, 422′ and 422″) and the 1FGE 424.

Referring now concurrently to FIGS. 7 and 8, the determination by the processor 510 that the pre-defined position is achieved, and the connections (423 and 423′) if the pre-defined position is achieved, are performed only if the 1FGE 424 and the at least one 2fGEs (422 and 422″) are located in a specific section 440 of the display 540. The specific section 440 of the display 540 may be determined by an interaction of a user with the computer 500 via the user interface 550. Alternatively, the specific section 440 may be determined by a computation by the processor 510.

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. A computer-implemented method for interconnecting functional graphical elements, the method comprising:
identifying a first functional graphical element on a display of a computer;
identifying at least one second functional graphical element on the display;
determining by a processor of the computer that the at least one second functional graphical element has a pre-determined position on the display with respect to the first functional graphical element; and
functionally connecting the at least one second functional graphical element to the first functional graphical element.

2. The computer-implemented method of claim 1, wherein functionally connecting the at least one second functional graphical element to the first functional graphical element comprises memorizing in a memory of the computer the connection between the at least one second functional graphical element and the first functional graphical element.

3. The computer-implemented method of claim 1, wherein functionally connecting the at least one second functional graphical element to the first functional graphical element comprises displaying on the display a link between the at least one second functional graphical element and the first functional graphical element.

4. The computer-implemented method of claim 1, wherein the pre-determined position comprises the at least one second functional graphical element being on the left of the first functional graphical element.

5. The computer-implemented method of claim 4, wherein the pre-determined position further comprises the at least one second functional graphical element being at a pre-determined distance of the first functional graphical element.

6. The computer-implemented method of claim 4, wherein functionally connecting the at least one second functional graphical element to the first functional graphical element includes functionally connecting an output of the at least one second functional graphical element to an input of the first functional graphical element.

7. The computer-implemented method of claim 6, wherein one of the second functional graphical element represents a sensor and the output of the sensor outputs data related to environmental characteristic values.

8. The computer-implemented method of claim 7, wherein the first functional graphical element represents an environment controller.

9. The computer-implemented method of claim 1, wherein the pre-determined position comprises the at least one second functional graphical element being on the right of the first functional graphical element.

10. The computer-implemented method of claim 9, wherein the pre-determined position further comprises the at least one second functional graphical element being at a pre-determined distance of the first functional graphical element.

11. The computer-implemented method of claim 9, wherein functionally connecting the at least one second functional graphical element to the first functional graphical element includes functionally connecting an input of the at least one second functional graphical element to an output of the first functional graphical element.

12. The computer-implemented method of claim 1, wherein the first functional graphical element and the at least one second functional graphical element are located in a specific section of the display.

13. The computer-implemented method of claim 9, wherein the specific section of the display is determined by one of: an interaction of a user with the computer, a computation by the processor, and a combination thereof.

14. The computer-implemented method of claim 1, wherein the first functional graphical element is moved to a particular position on the display of the computer and the determination that the at least one second functional graphical element has a pre-determined position on the display with respect to the first functional graphical element is made with respect to the particular position of the first functional graphical element.

15. A computer program product deliverable via an electronically-readable media such as storage media and communication links, the computer program product comprising instructions for interconnecting functional graphical elements of devices that when executed by a processor perform the method of claim 1.
